(19) United States
(12) Patent Application Publication
(10) Pub. No.: US 2017/0052554 A1
(43) Pub. Date: Feb. 23, 2017

(54) POWER DEMAND CONTROL APPARATUS AND POWER DEMAND CONTROL METHOD

(71) Applicant: AZBIL CORPORATION, Chiyoda-ku (JP)

(72) Inventor: Tsutomu FUKAURA, Chiyoda-ku (JP)

(73) Assignee: AZBIL CORPORATION, Chiyoda-ku (JP)

(21) Appl. No.: 15/239,433

(22) Filed: Aug. 17, 2016

(30) Foreign Application Priority Data
Aug. 18, 2015 (JP) 2015-161110

(51) Int. Cl. G05F 1/66; G05B 13/02

(52) U.S. Cl. CPC G05F 1/66; G05B 13/026; G05B 2219/39361

(57) ABSTRACT

A power demand control apparatus includes a power consumption estimating unit that calculates estimated power consumption at a time when a current interval ends based on information indicating a power consumption history until a current time on a current day including the current interval and an estimated power consumption recalculating unit that recalculates the estimated power consumption using a correction factor calculated based on information indicating the power consumption history on past dates.

### CROSS-REFERENCE TO RELATED APPLICATIONS

The present application claims priority to Japanese Application No. 2015-161110, filed Aug. 18, 2015, the entire contents of which are incorporated herein by reference.

### FIELD

The disclosure relates to a power demand control apparatus and a power demand control method that estimate the entire power consumption at intervals that are set and perform disconnection-recovery of a power load so that the entire power consumption is kept within target power based on adjustment power calculated from the estimated power consumption.

### DESCRIPTION OF THE RELATED ART

Power demand control methods in related art are known, in which the entire power consumption is estimated at intervals that are set for power loads including electrical devices in facilities, adjustment power is calculated based on the difference between the estimated power consumption and target power that is set in advance, and disconnection-recovery of each power load is performed based on the adjustment power to keep the entire power consumption within the target power.

In such power demand control, a situation should be avoided in which the actual power consumption exceeds the estimated power consumption estimated at start of an interval and the control of the power load is made insufficient during the second half of the interval.

Accordingly, for example, Japanese Unexamined Patent Application Publication No. 4-183226 discloses a power demand control method in which each interval is divided into a first half and a second half and the cycle of a pulse integration time and a feasibility determination reference time during the first half is differentiated from that during the second half.

However, with the technology disclosed in Japanese Unexamined Patent Application Publication No. 4-183226, although the problem in that the control is insufficient for the target power is resolved, it may be necessary to stop a large number of devices at the same time during the remaining time period of the interval if the power usage is greatly increased during the second half of the interval. For example, there is a problem in that the impact on the operation, such as stop of all air conditioning devices, is increased.

### SUMMARY

Accordingly, it is an object of the disclosure to provide a power demand control apparatus and a power demand control method capable of power demand control in which the estimation accuracy of estimated power consumption is improved to reduce the impact on the operation.

The disclosure provides a power demand control apparatus including a power consumption estimating unit that calculates estimated power consumption at a time when a current interval ends based on information indicating a power consumption history until a current time on a current day including the current interval and an estimated power consumption recalculating unit that recalculates the estimated power consumption using a correction factor calculated based on information indicating the power consumption history on past dates.

According to the disclosure, it is possible to perform power demand control in which the estimation accuracy of the estimated power consumption is improved to reduce the impact on the operation.

### BRIEF DESCRIPTION OF THE DRAWINGS

FIG. 1 is a graph illustrating exemplary estimated power consumption in general power demand control;

FIG. 2 is a block diagram illustrating an exemplary configuration of a power demand control apparatus according to a first embodiment of the disclosure;

FIG. 3 is a flowchart illustrating an exemplary operational process performed by the power demand control apparatus according to the first embodiment of the disclosure;

FIG. 4 is a graph for describing an example of how to calculate estimated power consumption by a power consumption estimating unit in the first embodiment;

FIG. 5 is a graph illustrating the power consumption on the current day and the transition of the power consumption on the same day of week and in the same time zone one week before, which is the history of a past date, in the first embodiment;

FIG. 6 is a graph illustrating the power consumption on the current day and the transition of the power consumption on the same day of week and in the same time zone one week before, which is the history of a past date, in the first embodiment;

FIG. 7 is a block diagram illustrating an exemplary hardware configuration of the power demand control apparatus according to the first embodiment;

FIG. 8 is a flowchart illustrating an exemplary operational process performed by a power demand control apparatus according to a second embodiment of the disclosure;

FIG. 9 illustrates an example of the percentages of commanders one week before in the entire facility in the second embodiment; and

FIG. 10 illustrates an example of the percentages of the commanders on the current day in the entire facility in the second embodiment.

### DESCRIPTION OF THE PREFERRED EMBODIMENTS

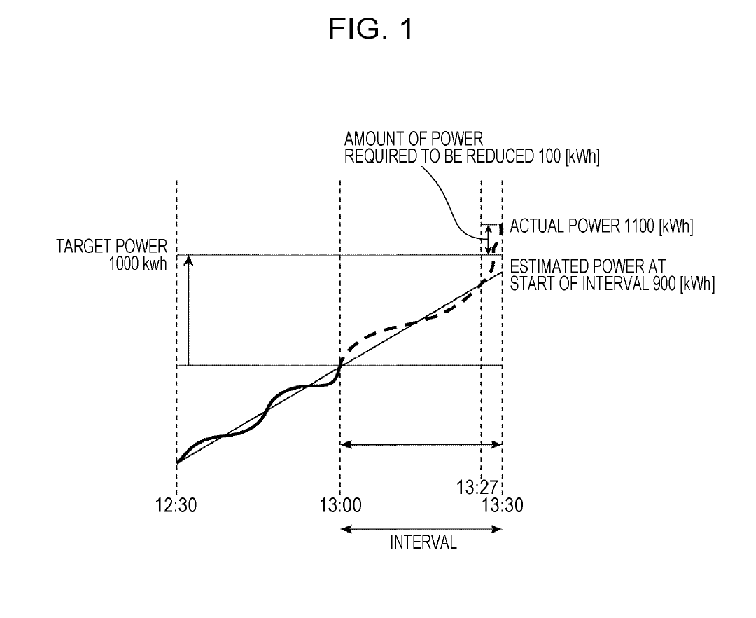

FIG. 1 is a graph illustrating exemplary estimated power consumption in general power demand control.

The general power demand control described in, for example, Japanese Unexamined Patent Application Publication No. 4-183226 will now be described with reference to FIG. 1. The disclosure is premised on the general power demand control described here.

In the general power demand control, the estimated power consumption is updated on a predetermined cycle, as needed. In a general power demand control method, the estimated power consumption is usually calculated using the latest power on the current day.

For example, the estimated power consumption at the time when the current interval ends is calculated based on the power consumption during the latest five minutes and disconnection-recovery of a power load is performed based on the result of comparison between the estimated power consumption and target power.

However, with the above method, when the power usage is greatly increased from 13:27, as in the example illustrated in FIG. 1, it is necessary to stop a large number of devices, for example, all air conditioning devices, at the same time during the remaining time period of the interval. Accordingly, the impact on the operation is increased even if the control is not insufficient for the target power.

The disclosure is provided to enable the disconnection-recovery with room left and improve the estimation accuracy of the estimated power consumption by correcting the estimated power consumption based on the past power usage state in order to reduce the impact on the operation in the power demand control.

Embodiments of the disclosure will herein be described in detail with reference to the attached drawings.

### First Embodiment

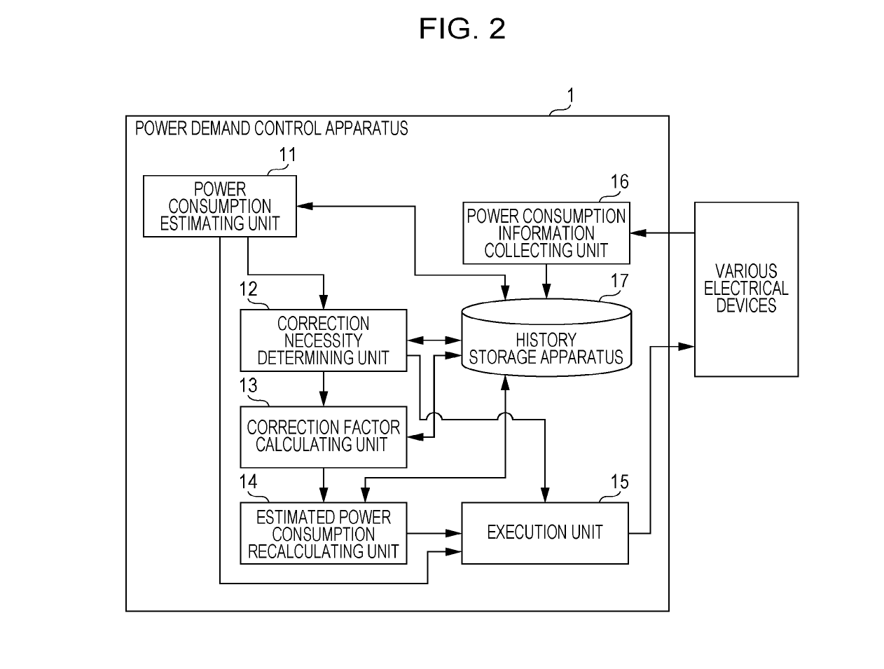

FIG. 2 is a block diagram illustrating an exemplary configuration of a power demand control apparatus 1 according to a first embodiment of the disclosure.

It is assumed in the first embodiment that the power demand control apparatus 1 controls the demand for various electrical devices, such as lights and air conditioning devices, in a facility, such as a building.

Referring to FIG. 2, the power demand control apparatus 1 includes a power consumption estimating unit 11, a correction necessity determining unit 12, a correction factor calculating unit 13, an estimated power consumption recalculating unit 14, an execution unit 15, a power consumption information collecting unit 16, and a history storage apparatus 17.

The power consumption information collecting unit 16 constantly collects information about power consumption from a certain time, for example, 0:00 am to the current time on the current day including the current interval from each electrical device and causes the history storage apparatus 17 to store the collected information about the power consumption. The power consumption information collecting unit 16 causes the history storage apparatus 17 to store the collected information about the power consumption of each electrical device in association with at least information, such as an identifier (ID), identifying each electrical device and information about the date, the day of week, and the time.

The history storage apparatus 17 stores a history of the power consumption of each electrical device.

The power consumption estimating unit 11 calculates the estimated power consumption at the time when the current interval ends based on information indicating the power consumption history until the current time with reference to the history storage apparatus 17 on a certain estimated power consumption calculation cycle.

The correction necessity determining unit 12 determines the necessity of correction of the estimated power consumption calculated by the power consumption estimating unit 11 based on the information indicating the power consumption history on a past date with reference to the history storage apparatus 17.

If the correction necessity determining unit 12 determines that the correction of the estimated power consumption is required, the correction factor calculating unit 13 calculates a correction factor used in recalculation of the estimated power consumption, that is, used in the correction of the estimated power consumption calculated by the power consumption estimating unit 11 based on the information indicating the power consumption history on a past date with reference to the history storage apparatus 17.

The estimated power consumption recalculating unit 14 recalculates the estimated power consumption using the correction factor calculated by the correction factor calculating unit 13. The recalculation performed by the estimated power consumption recalculating unit 14 corrects the estimated power consumption calculated by the power consumption estimating unit 11 to more appropriate estimated power consumption.

The execution unit 15 performs the disconnection-recovery of each electrical device, that is, each power load based on the estimated power consumption calculated by the power consumption estimating unit 11 or the estimated power consumption recalculated by the estimated power consumption recalculating unit 14.

An exemplary operation of the power demand control apparatus 1 will now be described.

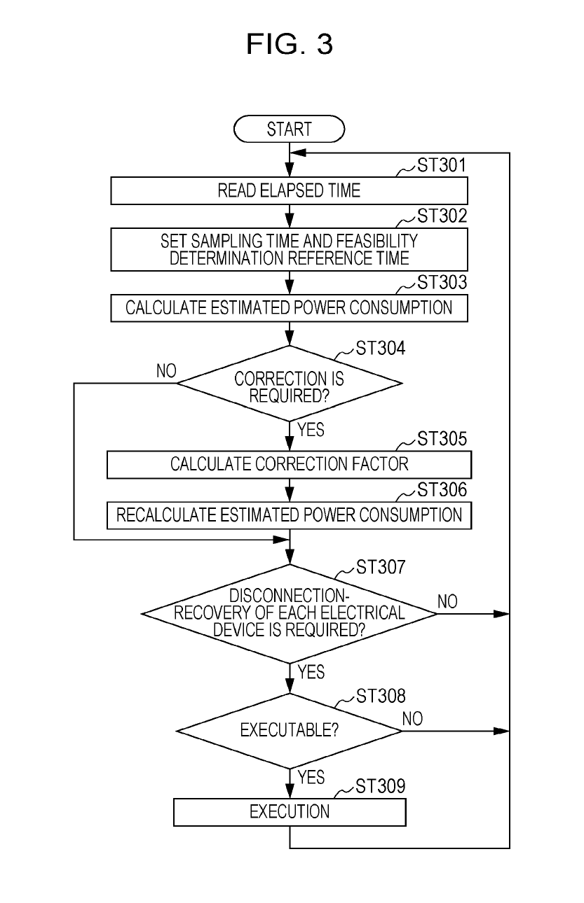

FIG. 3 is a flowchart illustrating an exemplary operational process performed by the power demand control apparatus 1 according to the first embodiment of the disclosure.

It is assumed in the following description that an interval time, which is the duration of each interval, is set to 30 minutes, for example, as illustrated in FIG. 1. It is also assumed that each interval is divided into a first half and a second half using a time when 25 minutes elapsed since each interval starts as a point of division.

A sampling time is set so as to be equal to a feasibility determination reference time. The sampling time and the feasibility determination reference time are set to five minutes during the first half of each interval and are set to one minute during the second half of each interval. The power consumption during a time period from a certain time before the current time to the current time is used in the calculation of the estimated power consumption and the time period from a certain time before the current time to the current time is referred to as the sampling time. The feasibility determination reference time is a time used to determine the necessity of the disconnection-recovery of each electrical device and will be described in detail below.

The estimated power consumption calculation cycle is set to one minute during both the first half and the second half of each interval.

The operational process described below with reference to FIG. 3 is performed every estimated power consumption calculation cycle.

Referring to FIG. 3, in Step ST301, the power consumption estimating unit 11 reads an elapsed time from the time when the current interval starts.

In Step ST302, the power consumption estimating unit 11 sets the sampling time and the feasibility determination reference time based on the elapsed time read in Step ST301. Specifically, for example, when the current time is 13:00, the elapsed time is zero minute and the sampling time and the feasibility determination reference time are set to five minutes.

In Step ST303, the power consumption estimating unit 11 calculates the estimated power consumption at the time when the current interval ends based on the information indicating the power consumption history until the current time with reference to the history storage apparatus 17 and supplies the calculated estimated power consumption to the correction necessity determining unit 12 and the execution unit 15.

Specifically, the power consumption estimating unit 11 calculates the estimated power consumption using Equation (1).

The power consumption information collecting unit 16 constantly collects the information about the power consumption from each electrical device in the facility. Accordingly, the power consumption estimating unit 11 sums up the power consumptions from the respective electrical devices to calculate the entire power consumption at the current time or the like.

W_{f}(t)=Wₜ(t)+(Wₜ(t)−Wₜ(t−s))×(T−t)/s (1)

W_{f}(t): Estimated power consumption at a time t

Wₜ(t): Measured power consumption at the time t

s: Sampling time

T: Interval time

t: Elapsed time from the time when the current interval starts

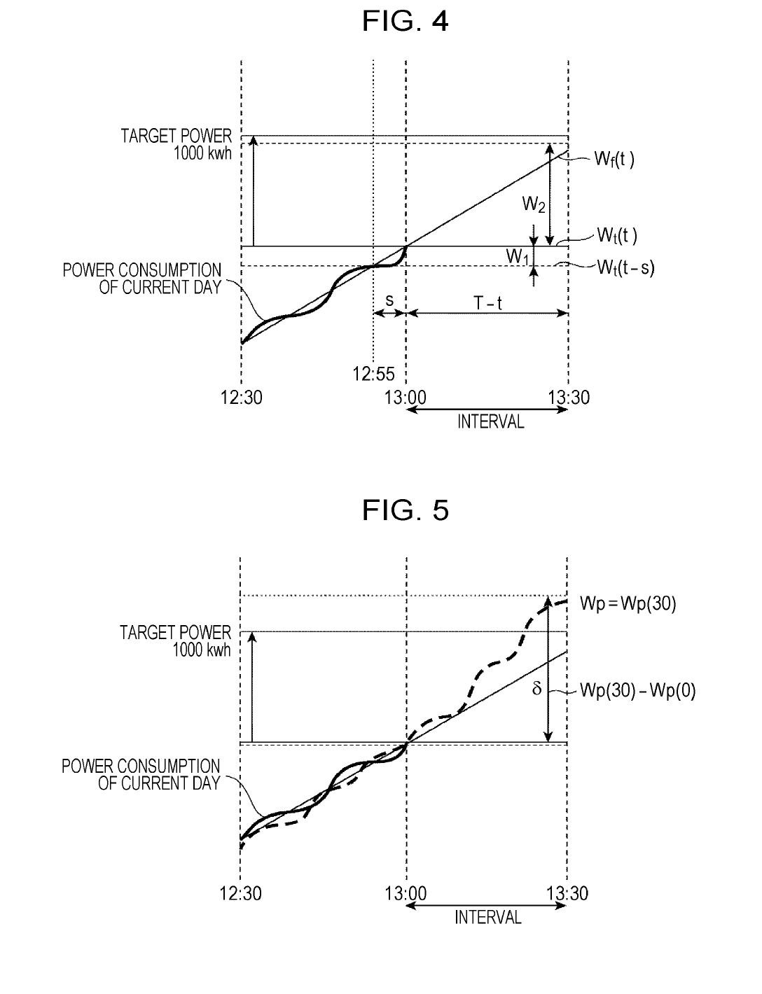

FIG. 4 is a graph for describing an example of how to calculate the estimated power consumption by the power consumption estimating unit 11.

For example, at 13:00 in FIG. 4, the estimated power consumption at the time when the current interval that starts at 13:00 ends is calculated.

The power consumption estimating unit 11 calculates estimated power consumption of 900 (kWh) according to Equation (1), where the power consumption Wₜ(t) at the current time 13:00 is 600 (kWh), the power consumption Wₜ(t−s) the sampling time before the current time is 550 (kWh), the interval remaining time T−t at the current time is 30 minutes, and the sampling time s is five minutes.

In Step ST304, the correction necessity determining unit 12 determines whether the correction of the estimated power consumption calculated by the power consumption estimating unit 11 is required with reference to the history storage apparatus 17.

The information about the power consumption constantly collected from each electrical device by the power consumption information collecting unit 16 is stored in the history storage apparatus 17 in association with at least the information, such as the ID, identifying each electrical device and the information about the date, the day of week, and the time.

In the first embodiment, the correction necessity determining unit 12 determines whether the correction of the estimated power consumption calculated by the power consumption estimating unit 11 is required from the transition of the power consumption on the same day of week and in the same time zone one week before with reference to the history storage apparatus 17.

For example, FIG. 5 is a graph illustrating transition Wₚ of the power consumption on the same day of week and in the same time zone one week before, which is the history of a past date, in addition to the power consumption on the current day.

As illustrated in FIG. 5, the power consumption on the same day of week and in the same time zone one week before is varied in substantially the same manner as in the power consumption on the current day until 13:00. However, the power consumption on the same day of week and in the same time zone one week before at 13:30 is 1,100 (kWh), which exceeds the target power. Specifically, although the estimated power consumption calculated in Step ST301 by the power consumption estimating unit 11 is 900 (kWh), power higher than the estimated power consumption by 200 (kWh) or more has been practically consumed on the same day of week and at the same time one week before. Accordingly, it is supposed that the estimation at the time when the interval starts is not good.

Here, the correction necessity determining unit 12 determines that the correction of the estimated power consumption calculated in Step ST303 by the power consumption estimating unit 11 is required.

The criterion used in the determination of whether the correction of the estimated power consumption is required by the correction necessity determining unit 12 is capable of being appropriately set in advance. Here, the correction necessity determining unit 12 determines that the correction of the estimated power consumption is required if the difference between the estimated power consumption at the time when the current interval ends and the power consumption on the same day of week and at the same time one week before is 50 (kWh) or more. It is sufficient for the correction necessity determining unit 12 to compare the estimated power consumption at a certain time, calculated by the power consumption estimating unit 11, with the power consumption on the same day of week and at the same time one week before to determine whether the correction of the estimated power consumption is required based on a predetermined criterion.

Instead of the above comparison, the determination of the necessity of the correction may be based on, for example, comparison between the difference between the power consumption at the current time and the estimated power consumption at the time when the current interval ends and the difference between the power consumption at the same time as the current time one week before and the power consumption at the same time as the time when the interval ends one week before. The determination of whether the correction is required may be based on whether the difference resulting from the comparison is higher than or equal to a predetermined threshold value.

In the former determination method, it is determined that the correction is required if the difference between the estimated value at the time when the interval ends and the past state is large. In the latter determination method, it is determined that the correction is required if the difference between the estimated value and the past state is large in terms of the increment from the current time to the time when the interval ends.

The determination methods of the above two kinds may be performed and the correction may be performed if it is determined that the correction is required in either of the determination methods of the above two kinds.

If the correction necessity determining unit 12 determines that the correction of the estimated power consumption is not required (NO in Step ST304), the correction necessity determining unit 12 supplies information indicating that the correction is not required to the correction factor calculating unit 13. The process skips Steps ST305 and ST306 and goes to Step ST307.

If the correction necessity determining unit 12 determines that the correction of the estimated power consumption is required (YES in Step ST304), the correction necessity determining unit 12 supplies information indicating that the correction is required to the correction factor calculating unit 13. In Step ST305, the correction factor calculating unit 13 calculates the correction factor used in the recalculation of the estimated power consumption based on the information indicating the power consumption history on a past date with reference to the history storage apparatus 17.

Specifically, the correction factor calculating unit 13 calculates the correction factor used in the recalculation of the estimated power consumption using Equation (2):

C(t)=((Wₚ(30)−Wₚ(0))−(Wₚ(0)−Wₚ(−30)))/(Wₚ(0)−Wₚ(−3C))×(T−t)/T (2)

C(t): Correction factor at the time t

Wₚ(t): Power consumption history value on a past date at the time corresponding to the elapsed time since the start of the interval

T: Interval time

where Wₚ(0) denotes the power consumption history value on the past date when t=0 (the time when the interval starts) and Wₚ(30) denotes the power consumption history value on the past date when t=30 (the time when the interval ends).

For example, when the time when the interval starts, which is 13:00, is set to t=0, the correction factor C(t) calculated by the correction factor calculating unit 13 is represented by Equation (3):

C(0)=((Wₚ(30)−Wₚ(0))−(Wₚ(0)−Wₚ(−30)))/(Wₚ(0)−Wₚ(−3C))×30/30 (3)

The correction factor when t=0 is calculated according to Equation (3). This correction factor may be said to be a growth rate of the amount of increase of the power consumption during the current interval on the past date when t=30 to the amount of increase of the power consumption during the last interval on the past date when t=0.

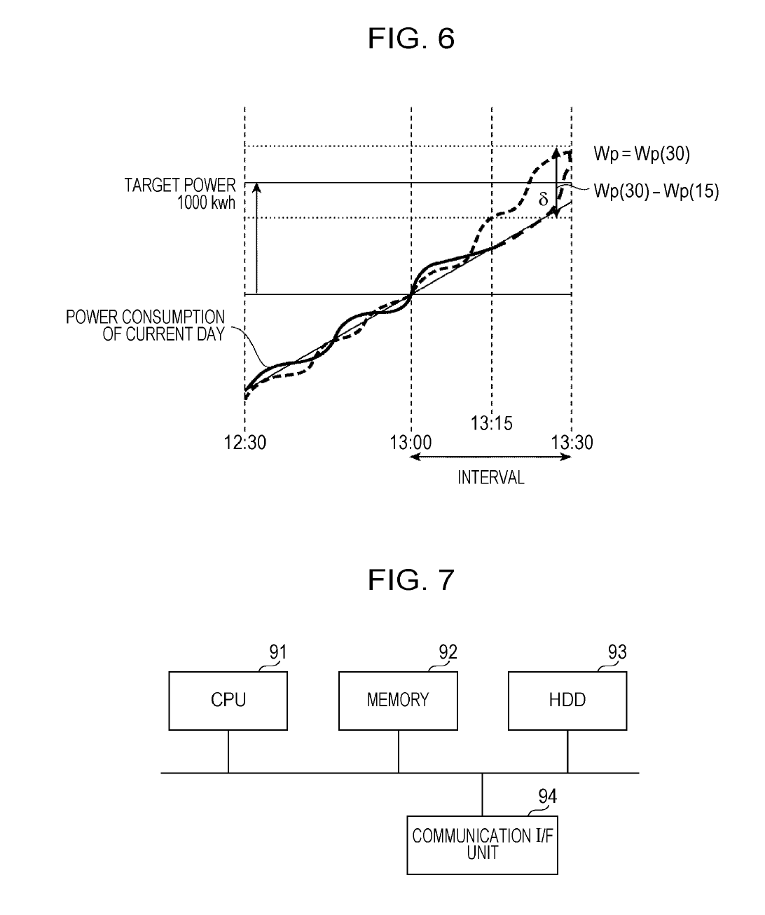

When 13:15 is set to t=15, as illustrated in FIG. 6, the correction factor C(t) calculated by the correction factor calculating unit 13 is represented by Equation (4):

C(15)=((Wₚ(30)−Wₚ(0))−(Wₚ(0)−Wₚ(−30)))/(Wₚ(0)−Wₚ(−3C))×15/30 (4)

The correction factor when t=15 is calculated according to Equation (4).

Referring back to FIG. 3, in Step ST306, the estimated power consumption recalculating unit 14 recalculates the estimated power consumption using the correction factor calculated in Step ST305 by the correction factor calculating unit 13. In other words, the recalculation here corrects the estimated power consumption calculated by the power consumption estimating unit 11 to more appropriate estimated power consumption.

Specifically, the estimated power consumption recalculating unit 14 recalculates the estimated power consumption using Equation (5) to calculate corrected estimated power consumption W_{f}′:

W_{f}′(t)=W(t)+(Wₜ(0)−Wₜ(−30))×C(t) (5)

W_{f}′(t): Corrected estimated power at the time t

In other words, at the time t, the difference in the current estimated power consumption is inferred by multiplying the amount of increase (Wₜ(0)−Wₜ(−30)) of the power consumption during the current last interval by the correction factor C(t) based on the amount of increase of the power consumption during the past last interval, calculated according to Equation (2), and the inferred difference is added to the current estimated power consumption W_{f}(t) to calculate the corrected estimated power consumption W_{f}′(t).

In Step ST307, the execution unit 15 determines whether the disconnection-recovery of each electrical device, that is, each power load is required based on the estimated power consumption.

Specifically, the execution unit 15 compares the estimated power consumption with a predetermined target value of the power consumption and, for example, if it is estimated that the power consumption will exceed the target value or if it is determined that the recovery is enabled through the subsequent variation for an electrical device that has been disconnected based on the past estimation, the execution unit 15 determines that the disconnection or the recovery of the corresponding electrical device, that is, the corresponding power load is required.

The estimated power consumption to be compared with the target value of the power consumption in Step ST307 by the execution unit 15 is the estimated power consumption calculated by the power consumption estimating unit 11 (NO in Step ST304) or the corrected estimated power consumption corrected through the recalculation by the estimated power consumption recalculating unit 14 (YES in Step ST304).

If the execution unit 15 determines that the disconnection-recovery of each electrical device, that is, each power load is not required (NO in Step ST307), the process skips Steps ST308 and ST309 and goes back to Step ST301. The subsequent steps are repeated on the certain estimated power consumption calculation cycle.

If the execution unit 15 determines that the disconnection-recovery of each electrical device, that is, each power load is required (YES in Step ST307), in Step ST308, the execution unit 15 determines whether the feasibility determination reference time or more elapsed since the previous disconnection-recovery. Specifically, the execution unit 15 determines whether five minutes or more elapsed since the previous disconnection-recovery when the current time is during the first half of the interval and determines whether one minute or more elapsed since the previous disconnection-recovery when the current time is during the second half of the interval. For example, when the current time is 13:00 in the example illustrated in FIG. 1, the execution unit 15 determines whether five minutes or more elapsed since the previous disconnection-recovery.

If the execution unit 15 determines that the feasibility determination reference time or more did not elapse since the previous disconnection-recovery (NO in Step ST308), the process skips Step ST309 and goes back to Step ST301.

If the execution unit 15 determines that the feasibility determination reference time or more elapsed since the previous disconnection-recovery (YES in Step ST308), in Step ST309, the execution unit 15 performs the disconnection-recovery of each electrical device, that is, each power load. After Step ST309, the process goes back to Step ST301.

Performing the disconnection-recovery of each electrical device, that is, each power load after the determination of whether the feasibility determination reference time or more elapsed in the above manner causes the impact of the change in the power consumption before the previous disconnection-recovery not to be applied on the result of calculation of adjustment power on the current cycle, thus preventing excess disconnection-recovery.

As described above, the correction of the estimated power consumption based on the power consumption history on a past date enables the power demand control in which the estimation accuracy of the estimated power consumption is improved to reduce the impact on the operation.

In the first embodiment, the correction necessity determining unit 12 determines the necessity of the correction of the estimated power consumption based on the power consumption on the same day of week and in the same time zone one week before and the correction factor calculating unit 13 calculates the correction factor based on the power consumption on the same day of week and in the same time zone one week before.

This is because the operation of the power load in the facility is similarly performed on the same day of week and the estimated power consumption is effectively corrected based on the power consumption history on the same day of week and in the same time zone.

However, the time in the past the determination of the necessity of the correction of the estimated power consumption and the calculation of the correction factor are based on is not limited to one week before. For example, the determination of the necessity of the correction of the estimated power consumption and the calculation of the correction factor may be based on the average of the power consumption histories on the same day of week and in the same time zone for several weeks or may be based on the power consumption history on the same date one year before. The time in the past the determination of the necessity of the correction of the estimated power consumption and the calculation of the correction factor are based on may be appropriately set.

Although the interval time is set to 30 minutes, the calculation cycle is set to one minute, and the sampling time and the feasibility determination reference time are set to five minutes or one minute in the first embodiment, these values may be arbitrarily selected. The sampling time and the feasibility determination reference time do not necessarily accurately coincide with each other and may be substantially similar values in order to achieve the desired effects.

FIG. 7 is a block diagram illustrating an exemplary hardware configuration of the power demand control apparatus 1 according to the first embodiment.

The history storage apparatus 17 uses a hard disk drive (HDD) 93 in the first embodiment of the disclosure. However, the use of the HDD 93 is only an example and the history storage apparatus 17 may be composed of a digital versatile disk (DVD), a memory 92, or the like.

The power consumption information collecting unit 16 uses a communication interface (I/F) unit 94.

The power consumption estimating unit 11, the correction necessity determining unit 12, the correction factor calculating unit 13, the estimated power consumption recalculating unit 14, and the execution unit 15 are realized by a central processing unit (CPU) 91 or a processing circuit, such as a system large scale integration (LSI), that executes programs stored in the HDD 93, the memory 92, and so on.

Multiple processing circuits may perform the above functions in cooperation with each other.

As described above, according to the first embodiment, the power demand control apparatus 1 includes the power consumption estimating unit 11 that calculates the estimated power consumption at the time when the current interval ends based on the information indicating the power consumption history until the current time on the current day including the current interval, the correction necessity determining unit 12 that determines the necessity of the correction of the estimated power consumption calculated by the power consumption estimating unit 11 based on the information indicating the power consumption history on a past date, and the estimated power consumption recalculating unit 14 that recalculates the estimated power consumption using the correction factor calculated based on the information indicating the power consumption history on the past date if the correction necessity determining unit 12 determines that the correction is required. Accordingly, it is possible to perform the power demand control in which the estimation accuracy of the estimated power consumption is improved to reduce the impact on the operation.

### Second Embodiment

The correction of the estimated power consumption based on the power consumption history on a past date is described in the first embodiment.

However, although the correction of the estimated power consumption based on the power consumption history on a past date is effective, the above correction is not constantly correct. For example, when the operation of the power load is greatly varied even on the same day of week, the transition of the power consumption may be greatly varied. Accordingly, it may be better not to apply the correction of the estimated power consumption based on the power consumption history on a past date in such a case.

In a second embodiment, only if it is determined that the correction of the estimated power consumption based on the power consumption history on a past date is appropriately performed in consideration of the current operation of the power load and the operation of the power load on the past date, the necessity of the correction of the estimated power consumption is determined and, if needed, the estimated power consumption is corrected.

Since the configuration of the power demand control apparatus 1 according to the second embodiment of the disclosure is the same as the one described in the first embodiment with reference to FIG. 2, a duplicated description of the configuration of the power demand control apparatus 1 according to the second embodiment is omitted herein.

Since the hardware configuration of the power demand control apparatus 1 according to the second embodiment of the disclosure is also the same as the one described in the first embodiment with reference to FIG. 7, a duplicated description of the hardware configuration of the power demand control apparatus 1 according to the second embodiment is omitted herein.

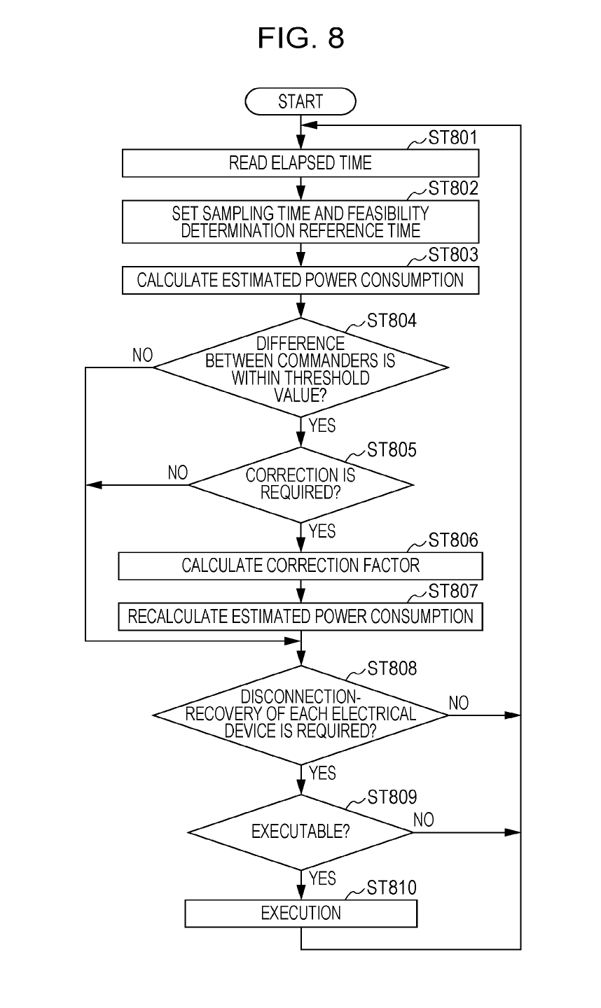

FIG. 8 is a flowchart illustrating an exemplary operational process performed by the power demand control apparatus 1 according to the second embodiment of the disclosure.

Since Steps ST801 to ST803 and Steps ST805 to ST810 in FIG. 8 are the same as Steps ST301 to ST309 in FIG. 3 described in the first embodiment, a duplicated description of the operational process performed by the power demand control apparatus 1 according to the second embodiment is omitted herein. Only Step ST804 different from the first embodiment will be described here.

The operation of the power load is generally varied for each facility. For example, in the case of air conditioning devices, various operation control methods are adopted, which include “schedule control”, “manual operation”, “power saving operation control”, and “event program control”. The various operation control methods are hereinafter referred to as “commanders” for description.

In addition, in the second embodiment, the power consumption information collecting unit 16 also collects information about the percentages of the commanders in the collection of the information about the power consumption from each electrical device and stores the collected information about the percentages of the commanders in the history storage apparatus 17.

In Step ST804, the correction necessity determining unit 12 determines whether the current operation status is close to the past operation status based on the past percentage of the commanders in the entire facility and the current percentage of the commanders in the entire facility. Specifically, the correction necessity determining unit 12 determines whether the difference between the current percentage of the commanders and the past percentage of the commanders is within a predetermined threshold value.

A specific example of Step ST804 will now be described.

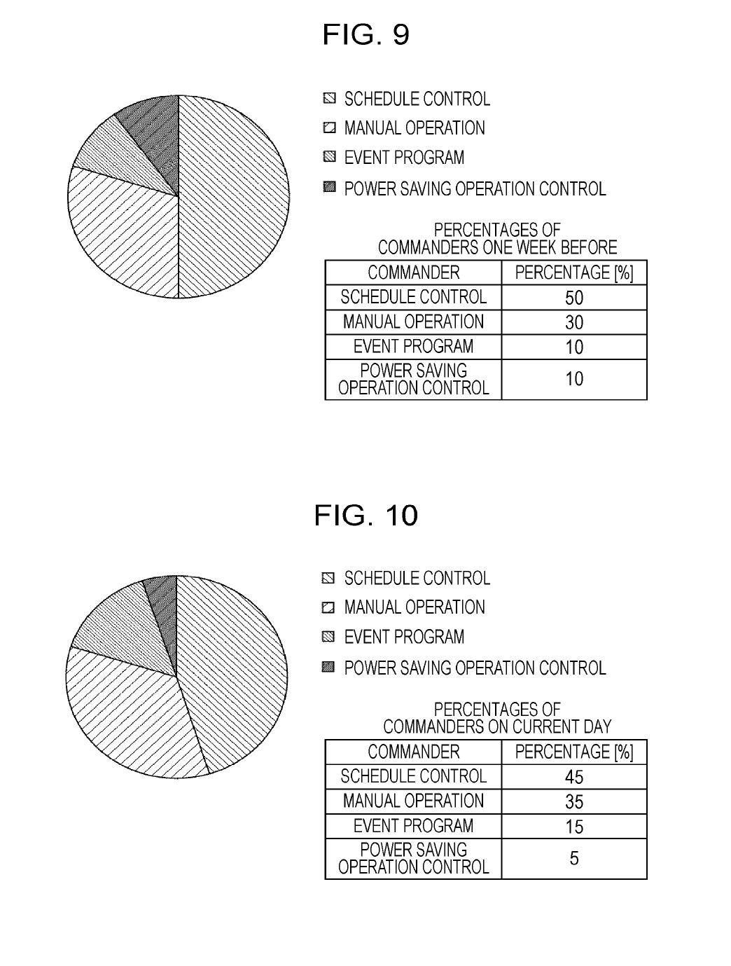

FIG. 9 illustrates an example of the percentages of the commanders one week before in the entire facility. FIG. 10 illustrates an example of the percentages of the commanders on the current day in the entire facility.

For example, only if the correction necessity determining unit 12 determines that the current operation status is close to the operation status one week before based on the percentages of the commanders illustrated in FIG. 9 and FIG. 10, the correction of the estimated power consumption is performed. The current operation status is determined from the operation status on the current day. The operation status one week before is used as the past operation status in the example in FIG. 9.

For example, if the correction necessity determining unit 12 determines that the difference between three higher commander percentages on the current day and the same three commander percentages one week before is within a predetermined threshold value, the correction of the estimated power consumption is performed.

In the examples in FIG. 9 and FIG. 10, the difference Δ=|50−45|+|30−35|+|10−15|=15. The correction of the estimated power consumption may be performed if the difference of 15 is within a predetermined threshold value. The predetermined threshold value may be appropriately set for each facility.

If the correction necessity determining unit 12 determines that the difference between the current commander percentages and the past commander percentages is within a predetermined threshold value (YES in Step ST804), the process goes to Step S805. If the correction necessity determining unit 12 determines that the difference between the current commander percentages and the past commander percentages is not within a predetermined threshold value (NO in Step ST804), the process skips Steps ST805 to ST807 and goes to Step ST808.

As described above, if the correction necessity determining unit 12 determines that the difference between the current commander percentages and the past commander percentages is not within a predetermined threshold value, the determination of the necessity of the correction of the estimated power consumption calculated by the power consumption estimating unit 11 (Step ST805), the calculation of the correction factor (Step ST806), and the recalculation of the estimated power consumption (Step ST807) are not performed. In other words, the disconnection-recovery of each electrical device, that is, each power load is performed by the execution unit 15, if needed, based on the estimated power consumption calculated by the power consumption estimating unit 11 regardless of the difference between the power consumption history on the current day and the power consumption history on a past date.

The recalculation of the estimated power consumption is not performed if it is determined that the correction based on the power consumption history on a past date should not be performed, as described above. This prevents the recalculation of the estimated power consumption, that is, the correction of the estimated power consumption from being inappropriately performed.

Although the commanders one week before are used as the past commanders to be compared with the commanders on the current day by the correction necessity determining unit 12 in the example described above, the past commanders to be compared with the commanders on the current day by the correction necessity determining unit 12 are not limited to the commanders one week before. However, the correction necessity determining unit 12 uses the commanders at the same time as a certain past time in the subsequent determination of the necessity of the correction (Step ST805) as the past commanders to be compared with the commanders on the current day.

As described above, according to the second embodiment, the correction necessity determining unit 12 determines the necessity of the correction if the difference between the commander percentages indicating the operation status on the current day and the commander percentages indicating the past operation status is within a predetermined threshold value. The necessity of the correction of the estimated power consumption is determined only if it is determined that the correction of the estimated power consumption based on the power consumption history on a past date is appropriately performed in consideration of the current operation of the power load and the operation of the power load on a past date and, if needed, the estimated power consumption is corrected, as described above. Accordingly, it is possible to further improve the estimation accuracy of the estimated power consumption.

Although the power consumption information collecting unit 16 and the history storage apparatus 17 are provided in the power demand control apparatus 1 in the first and second embodiments, as illustrated in FIG. 2, the provision of the power consumption information collecting unit 16 and the history storage apparatus 17 is not limited to this. The power consumption information collecting unit 16 and the history storage apparatus 17 may be provided outside the power demand control apparatus 1. In this case, the power consumption estimating unit 11, the correction necessity determining unit 12, the correction factor calculating unit 13, and the estimated power consumption recalculating unit 14 in the power demand control apparatus 1 may collect the power consumption history on a past date, stored in the history storage apparatus 17, for example, via the communication I/F unit.

Although the correction necessity determining unit 12 determines whether the correction of the estimated power consumption calculated by the power consumption estimating unit 11 is required and the recalculation of the estimated power consumption is performed if the correction necessity determining unit 12 determines that the correction is required in the first and second embodiments, the determination of the necessity of the correction by the correction necessity determining unit 12 may be omitted.

Specifically, in the first embodiment, the estimated power consumption recalculating unit 14 may constantly recalculate the estimated power consumption using the correction factor calculated based on the information indicating the power consumption history on a past date. In the second embodiment, the estimated power consumption recalculating unit 14 may constantly recalculate the estimated power consumption if the difference between the commanders indicating the operation status on the current day and the commanders indicating the operation status on a past date is within a predetermined threshold value.

Although the power demand control apparatus 1 has the configuration illustrated in FIG. 2 in the first and second embodiments, the above effects are capable of being achieved by providing the power consumption estimating unit 11 and the estimated power consumption recalculating unit 14 in the power demand control apparatus 1.

The embodiments may be combined or arbitrary components of the embodiments may be modified or omitted without departing from the true spirit and scope of the disclosure.

What is claimed is:

1. A power demand control apparatus, comprising:
a power consumption estimating unit configured to calculate estimated power consumption at a time when a current interval ends based on information indicating a power consumption history until a current time on a current day including the current interval; and
an estimated power consumption recalculating unit configured to recalculate the estimated power consumption using a correction factor calculated based on information indicating the power consumption history on past dates.

2. The power demand control apparatus according to claim 1,
wherein the correction factor is calculated based on the power consumption history at the same day of week as the current day in the power consumption history on the past dates.

3. The power demand control apparatus according to claim 1,
wherein the estimated power consumption recalculating unit recalculates the estimated power consumption if a difference between a commander indicating an operation status on the current day and a commander indicating an operation status on a past day is within a threshold value.

4. A power demand control method, comprising:
calculating estimated power consumption at a time when a current interval ends based on information indicating a power consumption history until a current time on a current day including the current interval by a power consumption estimating unit; and
recalculating the estimated power consumption using a correction factor calculated based on information indicating the power consumption history on a past date by an estimated power consumption recalculating unit.
